(19) United States
(12) Patent Application Publication
(10) Pub. No.: US 2025/0158240 A1
(43) Pub. Date: May 15, 2025

(54) BATTERY MODULE AND ELECTRICITY CONDUCTING MEMBER

(71) Applicant: KABUSHIKI KAISHA TOSHIBA, Tokyo (JP)

(72) Inventors: Yuto Shinohara, Yokosuka Kanagawa (JP); Takashi Ito, Fujisawa Kanagawa (JP); Takahiro Aizawa, Yokohama Kanagawa (JP)

(21) Appl. No.: 18/948,280

(22) Filed: Nov. 14, 2024

(30) Foreign Application Priority Data
Nov. 15, 2023 (JP) 2023-194556

(51) Int. Cl. H01M 50/522; H01M 50/51; H01M 50/526

(52) U.S. Cl. CPC H01M 50/522; H01M 50/51; H01M 50/526

(57) ABSTRACT

According to one embodiment, provided is a battery module including a plurality of single-batteries and a construction having a stacked structure. Each of the single-batteries includes a first electrode and a second electrode. The construction includes a first electrode lead electrically connected to the first electrode and including a hard metal, a second electrode lead electrically connected to the second electrode and including a soft metal having a lower hardness than the hard metal, and a slab including the hard metal. The stacked structure includes the slab, a part of the first electrode lead, and a layer of an intermetallic compound from the hard metal and the soft metal. The plurality of single-batteries is electrically connected in series by the construction.

### CROSS-REFERENCE TO RELATED APPLICATION(S)

This application is based upon and claims the benefit of priority from prior Japanese Patent Application No. 2023-194556, filed Nov. 15, 2023, the entire contents of which are incorporated herein by reference.

### FIELD

The present disclosure relates to a battery module and an electricity conducting member.

### BACKGROUND

Joining of dissimilar metals is often required in many fields. For example, as one approach to increase the capacity of a battery module which includes multiple single-batteries, a technique of forming electrical and serial connections of the cells (single-batteries) in the module is under consideration, whereupon a positive electrode lead and a negative electrode lead may be joined together. A positive electrode and a negative electrode differ from each other in operating potentials, properties of electrode materials, etc., and as such, metal materials constituting their respective electrode leads may differ from each other.

As an illustrative example, a case of an aqueous electrolyte battery which uses an aqueous electrolyte containing water as a main solvent component will be assumed. An aqueous electrolyte battery is anticipated to exhibit higher safety than a nonaqueous electrolyte battery which uses a nonaqueous electrolyte containing a flammable organic medium as a main solvent component, and accordingly, development of aqueous electrolyte batteries is ongoing with an intent of applications to a large capacity battery for stationary use. In one example, an aqueous electrolyte battery adopts titanium (Ti), which is a hard metal, for a positive electrode current collector and lead, and zinc (Zn), which is a soft metal, for a negative electrode current collector and lead. When implementing connection in series so as to increase capacity of a battery module with such aqueous electrolyte batteries, the positive electrode Ti lead and the negative electrode Zn lead would be joined together.

### BRIEF DESCRIPTION OF THE DRAWINGS

FIG. 1 is a perspective view schematically showing an exemplary battery module according to an embodiment.

FIG. 2 is a partially cut-out plan view schematically showing an exemplary single-battery included in the battery module according to an embodiment.

FIG. 3 is an enlarged sectional view schematically showing an example of section A indicated in FIG. 1.

FIG. 4 is an enlarged sectional view schematically showing another example of section A indicated in FIG. 1.

FIG. 5 is an exploded perspective view schematically showing an exemplary battery pack according to an embodiment.

FIG. 6 is a schematic sectional view showing an exemplary construction according to an embodiment.

FIG. 7 is a schematic sectional view showing another exemplary construction according to an embodiment.

FIG. 8 is a schematic sectional view showing one part in the manufacture of the construction according to an embodiment.

FIG. 9 is a schematic sectional view showing another part in the manufacture of the construction according to an embodiment.

### DETAILED DESCRIPTION

According to one embodiment, provided is a battery module including a plurality of single-batteries and a construction having a stacked structure. Each of the single-batteries includes a first electrode and a second electrode. The construction includes a first electrode lead electrically connected to the first electrode and including a hard metal, a second electrode lead electrically connected to the second electrode and including a soft metal having a lower hardness than the hard metal, and a slab including the hard metal. The stacked structure includes the slab, a part of the first electrode lead, and a layer of an intermetallic compound from the hard metal and the soft metal. The plurality of single-batteries is electrically connected in series by the construction.

According to another embodiment, provided is an electricity conducting member having a stacked structure. The electricity conducting member includes a first member including a hard metal, a second member including a soft metal having a lower hardness than the hard metal, and a slab including the hard metal. The stacked structure includes the slab, a part of the first member, and a layer of an intermetallic compound from the hard metal and the soft metal.

In instances where aqueous electrolyte batteries that use positive electrode Ti leads and negative electrode Zn leads are to be connected in series, joining of a thin positive electrode Ti lead and a thin negative electrode Zn lead each having a thickness of, for example, approximately 0.1 mm to 0.3 mm may be required. As techniques applicable to joining of dissimilar metal thin plates, melt welding such as resistance welding which is frequently employed for small parts, mechanical fastening utilizing rivets or the like, and solid phase diffusion joining such as friction joining and ultrasonic joining are known. However, melt welding could incur evaporation and sublimation of metals, which may result in generation of voids. In mechanical fastening, increased weight and cost of the obtained structure are of concern. Mechanical fastening also entails a risk of the thin plates being broken in the course of fastening. In friction joining, a risk of the soft metal being cleaved under load application is conceivable. Ultrasonic joining is regarded as a technique with less risk of cleavage since it uses a small load (approximately 1/10) as compared to friction joining; however, it still involves the possibility of deteriorating the strength of components due to thinning of components resulting from the sinking action of a joining tool.

A battery module according to an embodiment includes a plurality of single-batteries and a construction described below. The multiple single-batteries are electrically connected in series by such constructions.

The multiple single-batteries each include a first electrode and a second electrode. The first electrode and the second electrode serve as, for example, a positive electrode and a negative electrode of the corresponding single-battery, respectively, or a negative electrode and a positive electrode of the corresponding single-battery, respectively. That is, the first electrode and the second electrode are in a relationship of opposite poles with one another. In one example, each single-battery is a secondary battery. Illustrative examples of the secondary battery include a nonaqueous electrolyte battery, an aqueous electrolyte battery, etc. Further, the secondary battery is, in one example, a lithium ion battery.

The constructions included in the battery module each include a first electrode lead containing a hard metal, a second electrode lead containing a soft metal, and a slab containing a hard metal. The “hard metal” and “soft metal” herein are relative terms and are intended to mean that a first metal which is the main constituent of the first electrode lead and the slab has a higher hardness than that of a second metal which is the main constituent of the second electrode lead. Such hardness may be expressed in, for example, the Vickers hardness scale (unit: HV). The soft metal contained in the second electrode lead therefore has a lower hardness than that of the hard metal in the first electrode lead and the hard metal in the slab. The hard metal contained in the slab is the same as the hard metal contained in the first electrode lead. Each construction has a stacked structure which includes a layer of an intermetallic compound obtained from the hard metal and the soft metal, a part of the first electrode lead, and the slab. The construction is a joined body of the first electrode lead, the second electrode lead, and the slab.

The first electrode lead is electrically connected to a first electrode included in one of the multiple single-batteries in the battery module. The second electrode lead is electrically connected to a second electrode included in another single-battery in the battery module. In this manner, the multiple single-batteries are electrically connected in series via such constructions each functioning as a conductor.

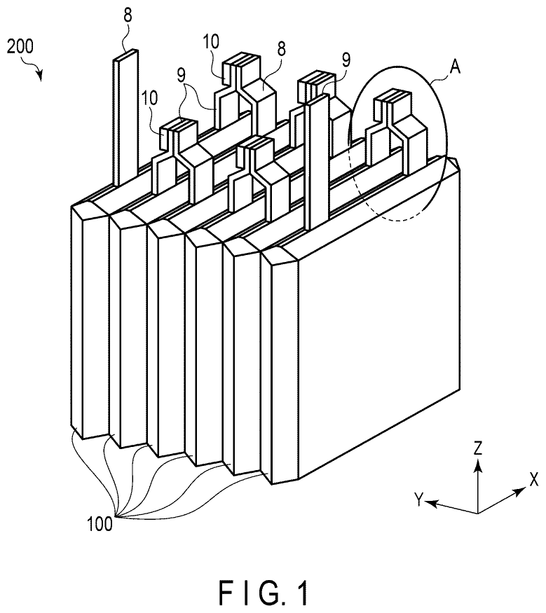

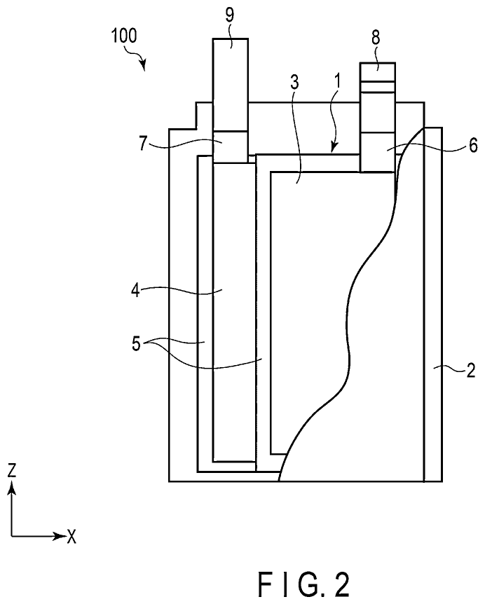

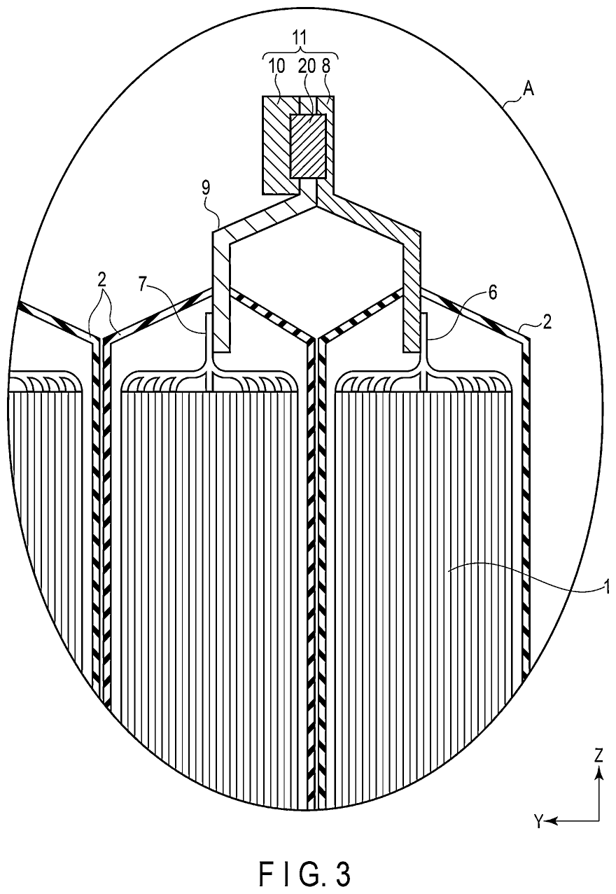

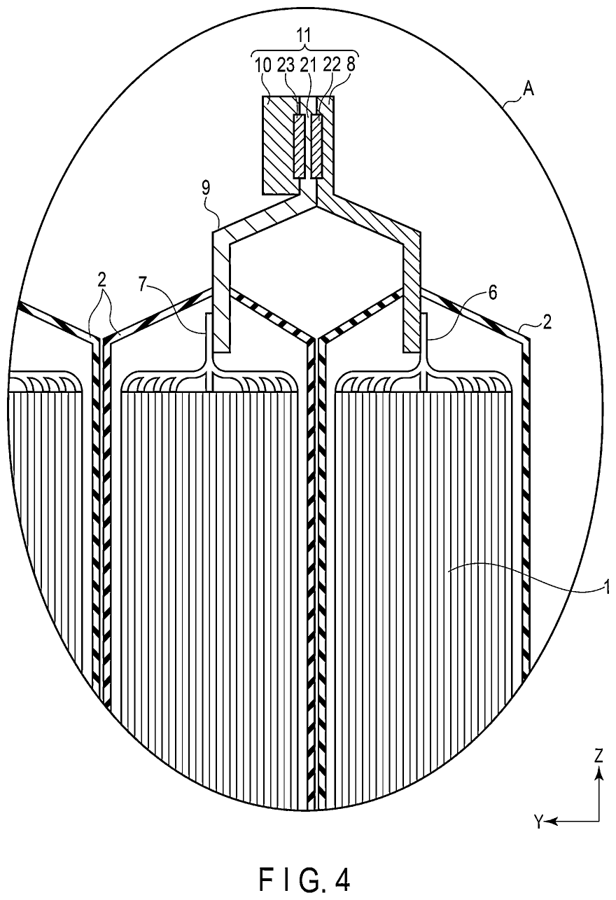

Examples of the battery module according to an embodiment will be described with reference to FIGS. 1 to 4. FIG. 1 is a perspective view schematically showing an exemplary battery module. A battery module 200 shown in the figure includes multiple single-batteries (battery cells) 100. FIG. 2 is a partially cut-out plan view schematically showing an exemplary single-battery included in this battery module, and this single-battery may represent, for example, the rightmost single-battery 100 shown in FIG. 1. The single-batteries 100 each include an electrode group 1 and a container 2 serving as a container member for accommodating the electrode group 1. Each of FIGS. 3 and 4 is an enlarged sectional view schematically showing an example of the portion A indicated in FIG. 1.

The electrode group 1 includes a first electrode 3 and a second electrode 4. In the electrode group 1, a separator 5 is interposed between the first electrode 3 and the second electrode 4. The separator 5 in the electrode group 1 is made of an electrically insulating material and electrically insulates the first electrode 3 from the second electrode 4.

The first electrode 3 includes, for example, a first current collector which may be a foil or the like containing a hard metal, and a first active material-containing layer supported on the surface of the first current collector (neither is illustrated in the drawings). While no limitations are intended, examples of the first current collector include a titanium foil, a titanium alloy foil, or a copper foil having a thickness of approximately 5 μm to 20 μm. The first active material-containing layer contains a first active material and may optionally contain a binder and an electro-conductive agent. The first electrode 3 may be one of the later described positive electrode and negative electrode.

The second electrode 4 includes, for example, a second current collector which may be a foil or the like containing a soft metal, and a second active material-containing layer supported on the surface of the second current collector (neither is illustrated in the drawings). While no limitations are intended, examples of the second current collector include a zinc foil, a zinc alloy foil, an aluminum foil, or an aluminum alloy foil having a thickness of approximately 5 μm to 20 μm. The second active material-containing layer contains a second active material and may optionally contain a binder and an electro-conductive agent. The second electrode 4 may be the other one of the later described positive electrode and negative electrode.

In the illustrated example, the electrode group 1 has a structure in which the first electrode 3 and the second electrode 4 are spirally wound into a flat shape with the separator 5 interposed therebetween. The electrode group 1 may have a stacked structure in which multiple positive electrodes and negative electrodes are alternately stacked with the separator(s) interposed therebetween. For the electrode group 1, a folded single separator 5 and/or multiple separators 5 may be adopted.

As shown in FIG. 2, strip-shaped first current-collecting tabs 6 are provided at respective parts of the end portions of the first electrode 3 that are located at the end surface of the electrode group 1. Each of the first current-collecting tabs 6 has electrical conductivity and is formed of, for example, the same material as that of the first current collector. Each of the first current-collecting tabs 6 may be formed integrally with a corresponding one of the first current collectors or formed separately from the first current collectors. A first electrode lead 8 having electrical conductivity is electrically connected to the first electrode 3. The electrical connection between the first electrode lead 8 and the first electrode 3 is made via, for example, the first current-collecting tabs 6. In one example, the first electrode lead 8 is connected to the multiple first current-collecting tabs 6 which are bundled together as shown in FIGS. 3 and 4. Alternatively, the first electrode lead 8 may be connected to the first electrode 3 without having any first current-collecting tab 6 interposed therebetween. In that case, the first current-collecting tabs 6 may be omitted. The first electrode lead 8 contains a hard metal which may be, for example, titanium, titanium alloy, or copper. The first electrode lead 8 is preferably formed of the same material as that of the first current-collecting tabs 6 or the first current collector. The first electrode lead 8 is, in one example, a belt-shaped sheet including a hard metal. The first electrode lead 8 may have a shape obtained by bending or folding such a sheet. The first electrode lead 8 may have a thickness of, for example, approximately 0.1 mm to 0.3 mm.

The first current-collecting tabs 6 may either be positive electrode current-collecting tabs or negative electrode current-collecting tabs. For example, if the first electrode 3 is a positive electrode, the first current-collecting tabs 6 serve as positive electrode current-collecting tabs, and if the first electrode 3 is a negative electrode, the first current-collecting tabs 6 serve as negative electrode current-collecting tabs. Similarly, the first electrode lead 8 may serve as a positive electrode lead or a negative electrode lead according to the first electrode 3 and the first current-collecting tabs 6.

Strip-shaped second current-collecting tabs 7 are provided at respective parts of the end portions of the second electrode 4 that are located at the aforementioned end surface of the electrode group 1 (see FIG. 2). Each of the second current-collecting tabs 7 has electrical conductivity and is formed of, for example, the same material as that of the second current collector. Each of the second current-collecting tabs 7 may be formed integrally with a corresponding one of the second current collectors or formed separately from the second current collectors. A second electrode lead 9 having electrical conductivity is electrically connected to the second electrode 4. The electrical connection between the second electrode lead 9 and the second electrode 4 is made via, for example, the second current-collecting tabs 7. In one example, the second electrode lead 9 is connected to the multiple second current-collecting tabs 7 which are bundled together as shown in FIGS. 3 and 4. Alternatively, the second electrode lead 9 may be connected to the second electrode 4 without having any second current-collecting tab 7 interposed therebetween. In that case, the second current-collecting tabs 7 may be omitted. The second electrode lead 9 contains a soft metal which may be, for example, zinc, zinc alloy, aluminum, or an aluminum alloy. The second electrode lead 9 is preferably formed of the same material as that of the second current-collecting tabs 7 or the second current collector. The second electrode lead 9 is, in one example, a belt-shaped sheet including a soft metal. The second electrode lead 9 may have a shape obtained by bending or folding such a sheet. The second electrode lead 9 may have a thickness of, for example, approximately 0.1 mm to 0.3 mm.

The second current-collecting tabs 7 may either be negative electrode current-collecting tabs or positive electrode current-collecting tabs. For example, if the second electrode 4 is a negative electrode, the second current-collecting tabs 7 serve as negative electrode current-collecting tabs, and if the second electrode 4 is a positive electrode, the second current-collecting tabs 7 serve as positive electrode current-collecting tabs. Similarly, the second electrode lead 9 may serve as a negative electrode lead or a positive electrode lead according to the second electrode 4 and the second current-collecting tabs 7.

The first electrode lead 8 and the second electrode lead 9 extend out of the container 2. A part of the first electrode lead 8 constitutes, together with a slab 10 and the second electrode lead 9 of another single-battery 100 differing from the corresponding single-battery 100, a construction. A part of the second electrode lead 9 constitutes, together with a slab 10 and the first electrode lead 8 of another single-battery 100 differing from the corresponding single-battery 100, a construction. Using such constructions each including the first electrode lead 8, the second electrode lead 9, and the slab 10, the single-batteries 100 are electrically connected in series within the battery module 200.

The slab 10 contains the same hard metal as that of the first electrode lead 8. The slab 10 contains, for example, titanium, titanium alloy, or copper. The slab 10 contains the hard metal at least in the surface part thereof, and a different material may be adopted for the internal part of the slab 10. For example, use of the slab 10 that has a structure in which a surface layer made of the hard metal is provided around a core part made of an affordable metal such as aluminum allows for the reduction in costs. Alternatively, the whole slab 10 may be made of a material including the hard metal.

Each construction has a stacked structure 11 which at least includes an intermetallic compound layer 20, the first electrode lead 8, and the slab 10. The stacked structure 11 may have, in one example, a three-layered structure of the first electrode lead 8, the intermetallic compound layer 20, and the slab 10 as shown in FIG. 3. More specifically, the intermetallic compound layer 20 is located between the slab 10 and a part of the first electrode lead 8 that is included in the stacked structure 11. The intermetallic compound layer 20 contains an intermetallic compound obtained from the hard metal employed in the first electrode lead 8 and the slab 10 and the soft metal employed in the second electrode lead 9. In an alternative example, the stacked structure 11 may include a five-layered structure as shown in FIG. 4. More specifically, the stacked structure 11 shown in FIG. 4 further includes a first layer 21 of the soft metal, and the intermetallic compound layer here includes, a second layer 22 located between the first layer 21 and a part of the first electrode lead 8, and a third layer 23 located between the first layer 21 and the slab 10. The soft metal first layer 21 may have the same composition as the second electrode lead 9. The first layer 21 may be a part of the second electrode lead 9 that is included in the stacked structure 11. The intermetallic compound second layer 22 contains an intermetallic compound obtained from the hard metal employed in the first electrode lead 8 and the soft metal employed in the second electrode lead 9. The intermetallic compound third layer 23 contains an intermetallic compound obtained from the hard metal employed in the slab 10 and the soft metal employed in the second electrode lead 9. The intermetallic compound second layer 22 and third layer 23 may have the same composition.

In both of the cases of the three-layered structure and the five-layered structure, the stacked structure 11 includes the layer(s) of an intermetallic compound between the hard metal and the soft metal. Since the stacked structure 11 has a sufficient thickness with the aid of the slab 10 functioning as a protective plate, the construction having such a stacked structure 11 is endowed with a high strength. Accordingly, the joint strength between the first electrode lead 8 and the second electrode lead 9 in the battery module 200 is high. The first electrode lead 8 and the second electrode lead 9 are placed in an electrically connected state, where electrical conduction is permitted via the construction. The single-batteries 100 are thus electrically connected to one another in series.

The container 2 may be, for example, a metal container, a laminate film container, or a resin container. As the metal container, a metal can made of nickel, iron, stainless steel, etc., may be adopted. For the laminate film container, for example, a multi-layered film including a metal layer covered with a resin layer may be used. Examples of the metal layer include a stainless-steel foil, an aluminum foil, and an aluminum alloy foil. The resin layer may be formed from polymers such as polypropylene (PP), polyethylene (PE), nylon, polyethylene terephthalate (PET), etc. As the resin container, a container made of PP, PE, etc., may be used.

Each single-battery 100 may further contain an electrolyte. Such an electrolyte may be a liquid electrolyte or a gel electrolyte, for example. A liquid electrolyte is prepared by dissolving an electrolyte salt as solute in a liquid solution as solvent. A gel electrolyte is prepared by combining a liquid electrolyte and a polymeric material. The electrolyte may be a nonaqueous electrolyte in which an organic solvent is used as the solvent, or an aqueous electrolyte in which an aqueous solvent is used as the solvent. Examples of the electrolyte salt include alkali salts such as lithium salts. Options of the electrolyte also include, in addition to a liquid electrolyte and a gel electrolyte, an ambient temperature molten salt (ionic melt), a polymer solid electrolyte, an inorganic solid electrolyte, etc., each containing lithium ions. Such a liquid electrolyte, gel electrolyte, and ambient temperature molten salt may be held in the electrode group 1. A solid electrolyte may be disposed between the first electrode 3 and the second electrode 4 in place of the separator 5. In this case, the first electrode 3 is electrically insulated from the second electrode 4 by the solid electrolyte in the electrode group 1.

The positive electrode includes, for example, a positive electrode current collector such as a positive electrode current-collecting foil, and a positive electrode active material-containing layer supported on the surface of the positive electrode current collector. While no limitations are intended, the positive electrode current collector is, for example, a titanium foil, a titanium alloy foil, an aluminum foil, or an aluminum alloy foil having a thickness of approximately 5 μm to 20 μm. The positive electrode active material-containing layer includes a positive electrode active material, and may optionally contain a binder and an electro-conductive agent. Examples of the positive electrode active material include, but are not limited to, oxides, sulfides, polymers, etc., which are capable of insertion-extraction of lithium ions.

The negative electrode includes, for example, a negative electrode current collector such as a negative electrode current-collecting foil, and a negative electrode active material-containing layer supported on the surface of the negative electrode current collector. While no limitations are intended, the negative electrode current collector is, for example, a zinc foil, a zinc alloy foil, or a copper foil having a thickness of approximately 5 μm to 20 μm. The negative electrode active material-containing layer includes a negative electrode active material, and may optionally contain a binder and an electro-conductive agent. Examples of the negative electrode active material include, but are not particularly limited to, metal oxides, metal sulfides, metal nitrides, carbon materials, etc., which are capable of insertion-extraction of lithium ions.

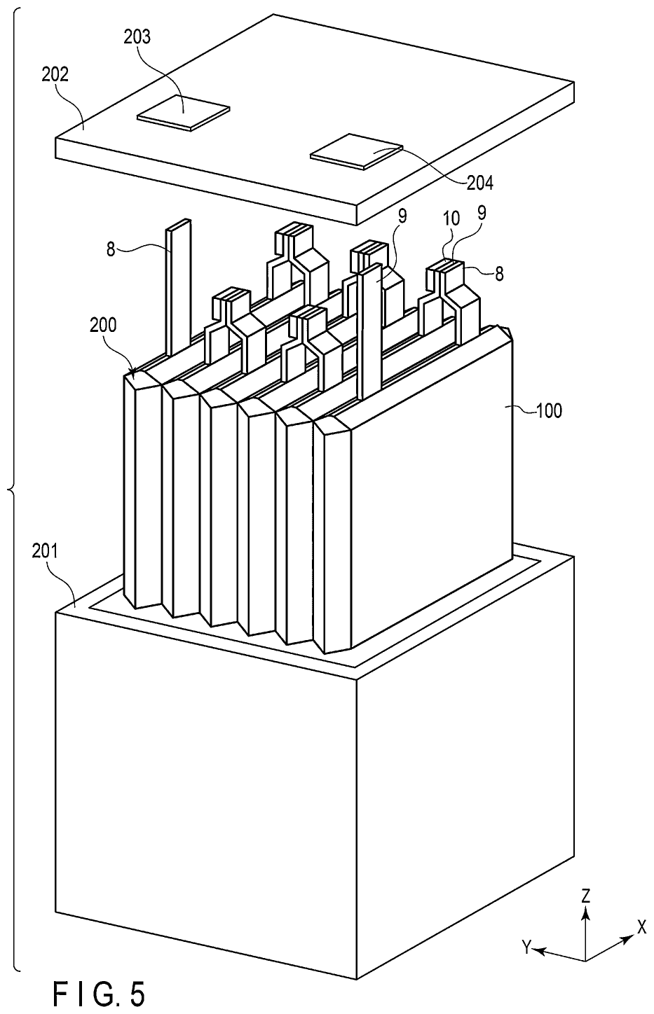

The battery module 200 may be, for example, housed in a housing container 201 and its lid 202, as shown in FIG. 5, so as to form a battery pack. In one example, the lid 202 is provided with a pair of external terminals 203 and 204, and the first electrode lead 8 and the second electrode lead 9 are electrically connected to the external terminals 203 and 204, respectively. Power can be supplied to the single-batteries 100 included in the battery module 200, and also power can be output from the single-batteries 100, via the external terminals 203 and 204. Locations of these external terminals 203 and 204 for electrical conduction are not limited to the top part of the lid 202, and the external terminals 203 and 204 may be provided, for example, at the side surface(s) of the housing container 201. The battery pack may also include, for example, a charge-and-discharge controlling device such as a protective circuit, in addition to the battery module 200.

Exemplary applications of the construction serving as a coupling member for electrically connecting the single-batteries 100 to each other have been described, but the subjects of application thereof are not limited to batteries. The above described construction provided as a coupling member in the battery module 200 is an illustrative example which includes the first electrode lead 8 and the second electrode lead 9 as a first member and a second member, respectively. The first member and the second member are not limited to electrode leads, but they may be, for example, other electrically conductive members.

The construction according to an embodiment includes the first member containing a hard metal, the second member containing a soft metal, and a slab containing a hard metal. The soft metal contained in the second member has a lower hardness than that of the hard metal in the first member and the hard metal in the slab. The hard metal contained in the slab is the same as the hard metal contained in the first member. The construction has a stacked structure including the slab, a part of the first member, and a layer of an intermetallic compound obtained from the hard metal and the soft metal. By having a stacked structure of this configuration, the construction realizes a high joint strength between the first member and the second member.

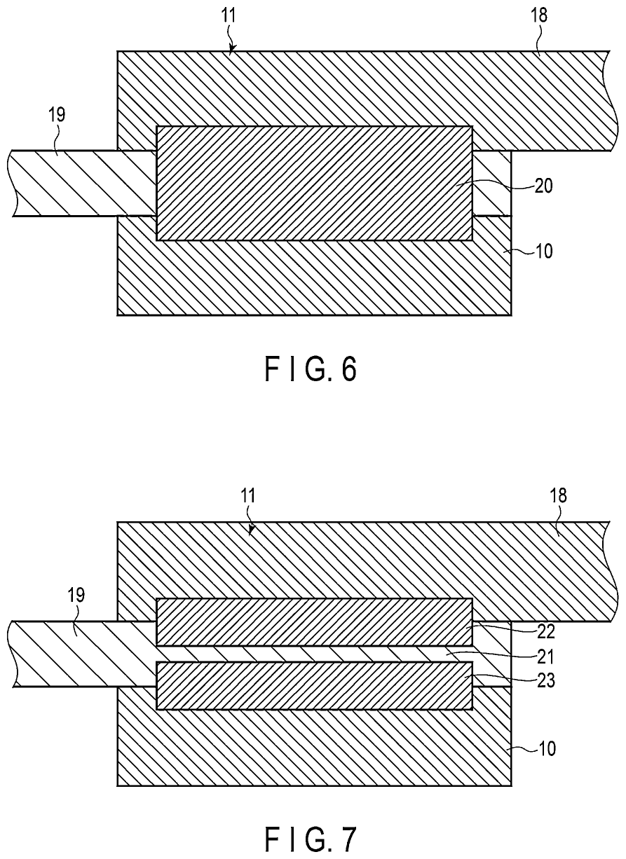

Examples of the construction according to the embodiment will be described with reference to FIGS. 6 and 7. Each of FIGS. 6 and 7 is a schematic sectional view showing an example of the construction according to the embodiment.

FIG. 6 shows an example of the construction having a stacked structure 11 that adopts a three-layered structure. The construction shown in the figure includes a first member 18 containing a hard metal, a second member 19 containing a soft metal, and a slab 10 containing the hard metal. The construction in FIG. 6 has the three-layered stacked structure 11 including the first member 18, an intermetallic compound layer 20, and the slab 10. More specifically, the intermetallic compound layer 20 is located between the slab 10 and a part of the first member 18 that is included in the stacked structure 11. The intermetallic compound layer 20 may be provided over any range as long as it is provided on at least a part of the slab 10. For example, the intermetallic compound layer 20 may be formed on a part of the surface of the slab 10 or on the entire surface of the slab 10. The intermetallic compound layer 20 contains an intermetallic compound obtained from the hard metal employed in the first member 18 and the slab 10 and the soft metal employed in the second member 19.

FIG. 7 shows an example of the construction having a stacked structure 11 that adopts a five-layered structure. The construction shown in the figure includes a first member 18 containing a hard metal, a second member 19 containing a soft metal, and a slab 10 containing the hard metal. The stacked structure 11 shown in FIG. 7 further includes a first layer 21 of the soft metal, and the intermetallic compound layer here is divided into, a second layer 22 located between the first layer 21 and a part of the first member 18, and a third layer 23 located between the first layer 21 and the slab 10. The soft metal first layer 21 may have the same composition as the second member 19. The first layer 21 may be a part of the second member 19 that is included in the stacked structure 11. The second layer 22 may be provided over any range as long as it is provided on at least a part of the first member 18. For example, the second layer 22 may be formed on a part of the surface of the first member 18 or on the entire surface of the first member 18. Similarly, the third layer 23 may be provided over any range as long as it is provided on at least a part of the slab 10. For example, the third layer 23 may be formed on a part of the surface of the slab 10 or on the entire surface of the slab 10. The intermetallic compound second layer 22 contains an intermetallic compound obtained from the hard metal employed in the first member 18 and the soft metal employed in the second member 19. The intermetallic compound third layer 23 contains an intermetallic compound obtained from the hard metal employed in the slab 10 and the soft metal employed in the second member 19.

In both of the cases of the three-layered structure and the five-layered structure, the stacked structure 11 includes the layer of an intermetallic compound between the hard metal and the soft metal. Since the stacked structure 11 has a sufficient thickness by virtue of including the slab 10 serving as a protective plate, the construction having such a stacked structure 11 has a high strength. Accordingly, the joint strength between the first member 18 and the second member 19 is high. The first member 18 and the second member 19 may each independently be a component of a to-be-joined object, or a member separate from the to-be-joined object. The first member 18 and the second member 19 are placed in an electrically connected state, where electrical conduction is permitted via the construction. In other words, such a construction may be used as, for example, an electricity conducting member.

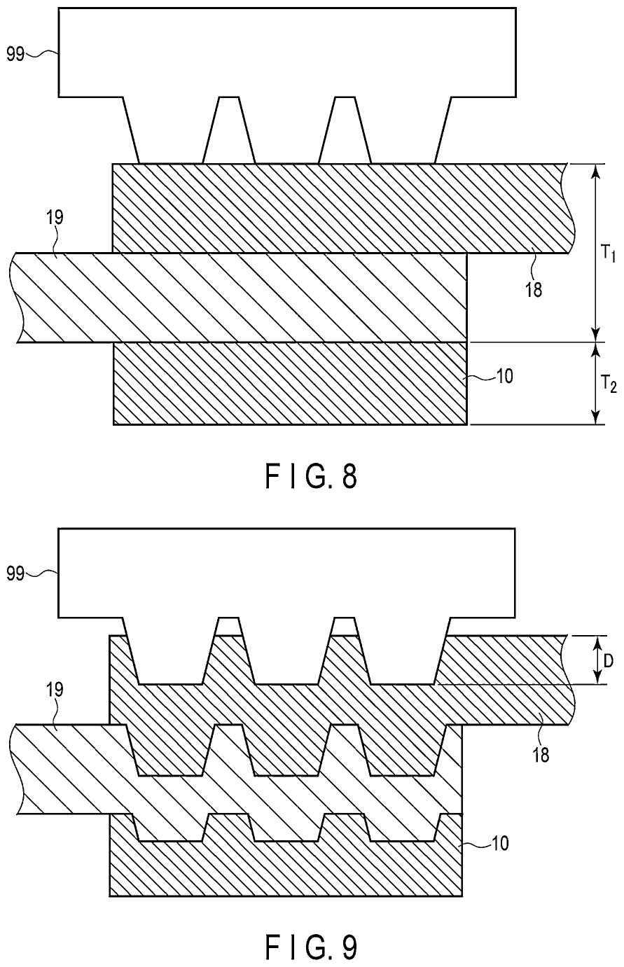

The construction according to the embodiment may be manufactured by a method including ultrasonic joining. One example of the manufacture will be described with reference to FIGS. 8 and 9. Each of FIGS. 8 and 9 is a schematic sectional view showing one part in the manufacture of the construction according to the embodiment.

As shown in FIG. 8, a first member 18 containing a hard metal and a second member 19 containing a soft metal are stacked on top of a slab 10 containing the hard metal. Here, the stacking order in terms of materials should be [hard metal/soft metal/hard metal]. Thus, the slab 10, the second member 19, and the first member 18 are disposed in this order from the bottom as shown in the figure.

A joining tool 99 for ultrasonic joining is brought in contact with the top of the hard metal first member 18. The joining tool 99 transmits ultrasonic vibrations to the first member 18, the second member 19, and the slab 10 so as to form an alloy of the hard metal and the soft metal and to thereby advance the joining of these members. As shown in FIG. 9, the joining tool 99 sinks down from the contact surface toward the inside of the first member 18 in the course of the ultrasonic joining, which concurrently causes deformation of the members in the positions corresponding to the sinking down of the joining tool 99. The deformation creates a part where the total thickness of the first member 18 and the second member 19 is reduced. The slab 10, disposed as a protective plate on the surface of the second member 19 that is opposite to the first member 18, is also joined to the second member 19 by the ultrasonic joining. The slab 10 is also deformed due to the sinking down of the joining tool 99. A sufficient thickness of the obtained stacked structure 11 as a whole is secured even at the positions where the deformation has occurred due to the sinking down of the joining tool 99, and accordingly, deterioration of the strength that would otherwise be incurred from the reduced thicknesses of the respective members can be prevented.

To this end, for example, the ultrasonic joining is conducted using the slab 10 having a thickness T₂ which is 25% or more of the total thickness T₁ of the first member 18 and the second member 19 (T₂/T₁×100%≥25%), with the second member 19 and the first member 18 stacked on top of the slab 10. Each of the members can be joined together by performing joining to an extent where a depth D of sinking by the joining tool 99 is 25% or more and 50% or less of the total thickness T₁ of the first member 18 and the second member 19. The slab 10, of which thickness T₂ is equal to or greater than such an extent of sinking, is not cleaved by the deformation produced by this extent of sinking. The thickness T₂ of the slab 10 is set to at least 25% of the total thickness T₁ of the first member 18 and the second member 19, and the thickness T₂ may be, for example, 50% or more of the total thickness T₁.

Note that, if the stacking order in terms of materials is changed to [soft metal/hard metal/soft metal], the joining of members is not accomplished even when application of ultrasonic wave is conducted until the joining tool 99 sinks down to a depth D corresponding to 50% of the total thickness of the soft metal first member and the hard metal second member.

The ultrasonic joining allows for the utilization of eutectic reactions between the hard metal and the soft metal, which enables welding at low temperature. Therefore, for example, a need to heat the constituent materials to their melting point is eliminated. In an example of specific combinations, the hard metal includes titanium (Ti) and the soft metal includes zinc (Zn). This combination can produce, for example, a Ti—Zn alloy as the intermetallic compound. In another example of combinations, the hard metal contains copper (Cu) and the soft metal contains aluminum (Al). This combination can produce, for example, a Cu—Al alloy as the intermetallic compound. In the Vickers hardness scale, titanium has a hardness of approximately 830 HV to 3420 HV and zinc has a hardness of approximately 30 HV to 50 HV. Copper has a hardness of approximately 343 HV to 369 HV and aluminum has a hardness of approximately 160 HV to 350 HV.

According to at least one embodiment described above, provided is a battery module including a plurality of single-batteries electrically connected in series. A construction connecting the plurality of single-batteries in series has a stacked structure including a slab, a part of a first electrode lead, and a layer of an intermetallic compound between a hard metal and a soft metal, respectively included in the first electrode lead and a second electrode lead. Since the aforementioned stacked structure includes the slab serving as a protective plate, the joint portion between each of the members in the stacked structure can be integrated having sufficient thickness, whereby the joint strength is high. Thereby, a battery module with highly reliable joining between single-batteries can be provided. There also is provided an electricity conducting member having the configuration of the above construction. The reliability of the electricity conducting member is high, for the reasons given above.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A battery module comprising:
a plurality of single-batteries each comprising a first electrode and a second electrode; and
a construction comprising a first electrode lead, a second electrode lead, and a slab,
the first electrode lead electrically connected to the first electrode and comprising a hard metal,
the second electrode lead electrically connected to the second electrode and comprising a soft metal having a lower hardness than the hard metal,
the slab comprising the hard metal,
the construction having a stacked structure which includes the slab, a part of the first electrode lead, and a layer of an intermetallic compound from the hard metal and the soft metal, and
the plurality of single-batteries being electrically connected in series by the construction.

2. The battery module according to claim 1, wherein the layer of the intermetallic compound is located between the slab and a part of the first electrode lead that is included in the stacked structure.

3. The battery module according to claim 2, wherein the stacked structure further includes a first layer of the soft metal, and the layer of the intermetallic compound comprises a second layer and a third layer, the second layer being located between the first layer and a part of the first electrode lead, and the third layer being located between the first layer and the slab.

4. The battery module according to claim 1, wherein the slab comprises the hard metal at least in a surface part thereof.

5. The battery module according to claim 1, wherein the hard metal comprises titanium, and the soft metal comprises zinc.

6. An electricity conducting member comprising:
a first member comprising a hard metal;
a second member comprising a soft metal having a lower hardness than the hard metal; and
a slab comprising the hard metal,
the electricity conducting member having a stacked structure which includes the slab, a part of the first member, and a layer of an intermetallic compound from the hard metal and the soft metal.

7. The electricity conducting member according to claim 6, wherein the layer of the intermetallic compound is located between the slab and a part of the first member that is included in the stacked structure.

8. The electricity conducting member according to claim 6, wherein the stacked structure further includes a first layer of the soft metal, and the layer of the intermetallic compound comprises a second layer and a third member, the second layer being located between the first layer and a part of the first member, and the third layer being located between the first layer and the slab.

9. The electricity conducting member according to claim 6, wherein the slab comprises the hard metal at least in a surface part thereof.
